(19) United States
(12) Patent Application Publication
(10) Pub. No.: US 2021/0308991 A1
(43) Pub. Date: Oct. 7, 2021

(54) INTERLAYERS AND LAMINATES INCORPORATING THE INTERLAYERS

(71) Applicant: Pleotint, LLC, Jenison, MI (US)

(72) Inventors: Michael D. Broekhuis, Grand Rapids, MI (US); Harlan Byker, Jenison, MI (US)

(21) Appl. No.: 17/221,758

(22) Filed: Apr. 2, 2021

Related U.S. Application Data
(60) Provisional application No. 63/004,291, filed on Apr. 2, 2020.

(51) Int. Cl. B32B 17/10; G02F 1/01; B32B 37/15

(52) U.S. Cl. CPC B32B 17/10477; G02F 1/0147; B32B 37/15; B32B 17/10036; B32B 17/10568

(57) ABSTRACT

A laminate comprising a printed interlayer, a first sheet of plastic or glass and a second sheet of plastic or glass. The interlayer is bonded between the first sheet and the second sheet. In another configuration, the first sheet and the second sheet are bonded together by the interlayer.

### CROSS-REFERENCE TO RELATED APPLICATIONS AND ISSUED PATENTS

This application claims priority from U.S. Patent Application Ser. No. 63/004,291, filed Apr. 2, 2020, entitled “INTERLAYERS AND LAMINATES INCORPORATING THE INTERLAYERS”, the entire specification of which is incorporated by reference.

While there is no claim of priority, the following United States patents are hereby incorporated in their entirety by reference: U.S. Pat. No. 10,807,346 Absorbing Solar Control Interlayers, U.S. Pat. No. 9,776,379 Absorbing Solar Control Interlayers, U.S. Pat. No. 9,465,239 Color Neutral Thermochromic Layers and Laminates, U.S. Pat. No. 9,321,251 Method and Constructions for Moisture Sensitive Layers and Structures Having Reduced Moisture Content in Moisture Sensitive Layers, U.S. Pat. No. 9,128,307 Enhanced Thermochromic Window which Incorporates a Film with Multiple Layers of Alternating Refractive Index, U.S. Pat. No. 9,011,734 Ligand Exchange Thermochromic, (LETC), Systems U.S. Pat. No. 8,623,243 Anti-yellowing for Thermochromic Systems, U.S. Pat. No. 8,431,045 Ligand Exchange Thermochromic Systems and High.epsilon.Ligands for Same, U.S. Pat. No. 8,182,718 Ligand Exchange Thermochromic Systems and High.epsilon.Ligands for Same, U.S. Pat. No. 8,154,788 Thermochromic Window Structures, U.S. Pat. No. 8,018,639 Ligand Exchange Thermochromic, (LETC), Systems, U.S. Pat. No. 7,817,328 Thermochromic Window Structures, U.S. Pat. No. 7,542,196 Ligand Exchange Thermochromic, (LETC), Systems, U.S. Pat. No. 7,538,931 Ligand Exchange Thermochromic Systems Containing Exchange Metals, U.S. Pat. No. 7,525,717 Multi-layer Ligand Exchange Thermochromic Systems.

While there is no claim of priority, the following published United States patent applications are hereby incorporated in their entirety by reference: US20190232619 Laminates and Methods with Multiple Interlayers and Multiple Substrates, US20180328102 Combination Dynamic and Switchable Window Glass Units, US20170028686 Durable and Lightweight Glazing Units, US20160138324 Vacuum Windows with Reticulated Spacer, US20150202846 Reflective and Conductive Coating Directly on PVB, US20130286461 Synergistic Reversible Chromism.

### BACKGROUND OF THE DISCLOSURE

### 1. Field of the Disclosure

The disclosure relates in general to interlayers, and more particularly, to interlayers and laminates incorporating such interlayers. While not specifically limited, the laminates are often utilized in windows.

### 2. Background Art

Interlayers are often used to bond two or more substrates together to form laminates. These laminates are often used as mono-pane or monolithic windows. Alternately, the laminates are used as a pane of a double pane or a multi-pane window. Laminates are particularly useful for windows in safety glass, transportation, bullet resistant, impact and blast resistant and/or thermochromic dynamic windows.

Generally, the interlayer materials for lamination are made into films or sheets by an extrusion or extrusion cast process. The films or sheets are then cut to size for virtually any shape or size of substrates to be laminated together. This may result in substantial waste as the unused trim produced during cutting to size can be significant. In typical high-volume lamination operations, the theoretical yield for interlayer utilization is only about 75-80%.

Printing methods like certain types of 3D printing or similar printing methods, involve a strand or filament of thermoplastic polymer which is fed through a heated nozzle or an extruder head and deposited on a bed or platen. It has recently been demonstrated that thermoplastic resin in the form of pellets in a hopper could be fed directly into a dispenser or extruder and print patterns of thermoplastic at high speeds for large area, high volume applications. While the print heads and printing methods of interest come from 3D printing technology they may be used in some embodiments in what is essentially a 2D printing application where an interlayer is formed directly on a substrate. Whether the interlayer printing is 2D or 3D, or it involves so called “fused filament fabrication” or “fused deposition modeling” or prints from a pre-existing filament or from pellets in a hopper, whereby an interlayer is formed directly on a substrate. The advantages of materials use and unique capabilities are disclosed herein.

It is known to use polyvinyl butyral, (PVB), as a thermoplastic material in 3D printing. But this has been suggested for printing three dimensional objects like typical 3D printing and PVB is simply suggested as an alternative to materials like acrylonitrile butadiene styrene, (ABS), polylactic acid, (PLA), and polyethylene terephthalate glycol-modified, (PETG). Herein printing of PVB and/or other materials is suggested for printing interlayers and in some cases for printing essentially 2D structures for use as interlayers in preparing laminates. Often the interlayers are printed directly on substrates that are subsequently used with one or more than one additional substrate to form laminates.

### SUMMARY OF THE DISCLOSURE

While it is well known to print pictures and patterns “on” interlayer films or materials or on a layer in an interlayer stack, we disclose herein printed interlayers and printing techniques to print or produce one or more of the layers of the interlayer material itself. These printed interlayers printed on substrates like sheets of glass and/or sheet of plastic plastic provide improved materials utilization and, while not obvious, once constructed into laminates may exhibit significant advantages over conventional interlayers and laminates as described in detail herein.

In the present disclosure, interlayers are printed by extruding or dispensing strands, filaments or profiles of interlayer materials onto substrates to form layers for lamination. Typically, a series of rows are deposited until a uniform film is formed that covers all or much of the surface area of the substrate.

In one embodiment involving printed interlayers and laminates made with the printed interlayers, the strands, filaments or profiles are deposited on a substrate in a fashion such that they butt up against each other and preferably bond to the previous strand, filament or profile such that the interfaces between strands, filaments or profiles may not be visible to a user or that the interfaces substantially or entirely disappear in subsequent processing. The entire thickness of the interlayer may be built up by depositing a single layer or by depositing several layers of strands, filaments or profiles of one or more types of interlayer material. In another embodiment the interlayer material is printed thicker than the intended final interlayer film or sheet thickness and is only printed in an array or pattern of, for example spaced apart lines that are not butted up against each other. This can dramatically speed the printing process. In this case a continuous perimeter or edge seal of the interlayer material or some other edge seal material can be provided and the laminate can be formed or at least tacked in a vacuum lamination process, especially a vacuum platen lamination, VPL, process. Subsequent to the vacuum lamination the laminate can be heated allowing the interlayer to flow and cover all or substantially all of the laminate area. Remarkably during the subsequent heating some interlayer material flows into all the vacuum or reduced pressure containing areas and volumes to form the substantially uniform coverage of interlayer in the laminate. The combination of printed interlayers and VPL processing of the printed interlayer and substrates into laminates is one key aspect of the inventions disclosed herein. Whether continuous or non-continuous, printing the interlayer directly on the substrates only in the areas of the substrates to be laminated raises the theoretical yield of interlayer materials or interlayer resin used in the laminates to near 100% as there is little or no trim material as there is with conventional preformed interlayer sheet used in laminate production.

The printed interlayers of the disclosure generally transmit at least some visible light and once printed they form sheets or films or at least take the place of sheets or films that cover most, or all of the area of the typical substrates being laminated. In general, at least one of the substrates transmits at least some visible light and a preferred application is light transmitting laminates for windows. Another preferred application is laminates of solar cells with a clear glass or plastic cover sheet.

The disclosure further discloses a laminate that comprises a printed interlayer that is formed by the printing of the interlayer material itself often directly on the substrate. The material forming the interlayer is printed as a continuous or semi-continuous layer of uniform or non-uniform thickness. Alternately the material forming the interlayer is printed in a non-continuous pattern and forms a substantial continuous sheet, film or layer in subsequent processing. Preferably the interlayer is printed from thermoplastic materials that are in the form or filaments, strands or pellets. The printed interlayer material may include latent crosslinking capability. Preferably the interlayer is printed as a light transmitting film or layer. Preferably the interlayer is printed to size on one or both of the substrates used to form a laminate. The laminate is formed by using the printed interlayer(s) to bond together two or more substrates. Preferably one or both substrates are light transmitting. The interlayer bonds a substantial portion of the area of a first substrate to a second substrate. The substrates may have the same area or different areas. In some cases, the interlayer bonds at least 50% of the area of the first substrate to the second substrate.

In some aspects of the disclosure, the disclosure is directed to a laminate comprising a printed interlayer, a first sheet or substrate of plastic or glass and a second sheet or substrate of plastic or glass wherein the interlayer is bonded between the first sheet or substrate and the second sheet or substrate.

In an aspect of the disclosure, the disclosure is directed to a method of forming a laminate comprising: providing a first substrate having an inner surface and an outer surface; providing a second substrate having an inner surface and an outer surface; printing at least one interlayer over at least a portion of the inner surface of at least one of the first substrate and second substrate; positioning the first substrate over the second substrate so that the inner surface of the first substrate faces the inner surface of the second surface so as to sandwich the at least one interlayer therebetween; pressing the first and second substrates together to join the first and second substrates through the at least one interlayer.

In some configurations, the at least one interlayer comprises a plurality of interlayers that are printed on at least one of the first substrate, the second substrate and another interlayer.

In some configurations, the step of printing further comprises the step of: printing a first interlayer defining a first outer boundary on at least a portion of the inner surface of at least one of the first substrate and second substrate; and printing a second interlayer defining a second boundary on at least a portion of the inner surface of the at least one of the first substrate and second substrate. In such a configuration, the first outer boundary and the second outer boundary are spaced apart from each other. Additionally, the step of pressing the first and second substrates together further comprises the step of: pressing the first and second substrates so that at least a portion of the first boundary layer contacts the second boundary layer which were spaced apart from each other prior to pressing.

In some configurations, the first outer boundary and the second outer boundary are completely free from contact prior to the step of pressing.

In some configurations, the step of pressing further includes the step of maintaining a portion of the first outer boundary and the second outer boundary spaced apart from each other upon conclusion of the pressing step.

In some configurations, the method further comprises the step of applying heat to at least one of the first substrate, the second substrate and the at least one interlayer during the step of pressing.

In some configurations, the step of pressing comprises the step of directing the first and second substrates between nip rollers.

In some configurations, the step of printing further comprises the step of printing at least one first interlayer to the inner surface of the first substrate and printing at least one second interlayer to the inner surface of the second substrate.

In some configurations, the step of pressing further comprises the step of pressing the at least one first interlayer into the at least one second interlayer.

In some configurations, the step of printing further comprises the step of printing at least one interlayer in a pattern such that a portion of the inner surface of each of the first and second substrates remains unprinted. The step of pressing further results in the formation of at least one void between the first substrate and second substrate in the step of pressing, wherein the at least one void is surrounded by a portion of the at least one interlayer.

In some configurations, the method further includes the step of inserting a component between the inner surface and outer surface which remains unprinted so as to embed a component therein.

In some configurations, at least one of the interlayers comprises at least one of a separator layer and an acoustic layer.

In some configurations, the at least one interlayer comprises at least two interlayers, wherein the first interlayer is different than the second interlayer in at least one property. In some configurations, the at least one property comprises a color, a thickness, a chemical constituent.

In some configurations, the inner layer of at least one of the first and second substrates comprises a non-uniform surface. The step of printing further comprises the step of print a substantially uniform layer on the non-uniform surface.

In some configurations the non-uniform surface comprises a bent surface.

In some configurations, the at least one interlayer comprises a thermochromic interlayer.

In some configurations, the step of printing comprises one of the steps of printing using a plurality of pellets and using a filament.

In some configurations, the at least one interlayer comprises an oriented material, comprising at least one of a liquid crystal, UV, visible and NIR reflective flakes.

In some configurations, the step of printing comprises the step of printing a non-uniform thickness interlayer.

In some configurations, the step of pressing further includes the step of applying a vacuum and pressure to the first substrate, second substrate and the at least one interlayer.

In some configurations, the step of applying utilizes a vacuum pressure laminator.

In another aspect of the disclosure, the disclosure is directed to a laminate formed utilizing any one of the above processes and methods.

In another aspect of the disclosure, the disclosure is directed to a laminate comprising a first substrate, a second substrate and at least one interlayer. The first substrate has an outer layer and an inner layer. The second substrate has an outer layer and an inner layer. The at least one interlayer is printed on the inner surface of one of the first substrate and second substrate and pressingly joined to the other of the first substrate and second substrate.

In some configurations, the at least one interlayer further comprises a first interlayer and a second interlayer. The first interlayer has a first outer boundary that is printed on the inner surface of one of the first substrate and the second substrate. The second interlayer has a second outer boundary that is printed on the inner surface of one of the first substrate and second substrate. The first outer boundary is at least one of spaced apart from the second outer boundary and contacting the second outer boundary.

In some configurations, the first interlayer and the second interlayer are different.

In some configurations, the interlayer is non-uniform, and preferably forms a wedge, among other three dimensional topographies.

In some configurations, the at least one interlayer comprises a plurality of interlayers. At least one of the plurality of interlayers is printed upon an inner surface of at least one of the first and second substrates. Other interlayers of the plurality of interlayers is printed upon anther interlayer or the inner surface of at least one of the first substrate and second substrate.

In some configurations, the first substrate and second substrate each comprise one of glass or plastic that is somewhat light transmitting, and the at least one interlayer is somewhat light transmitting.

In some configurations, the laminate includes voids defined in the at least one interlayer between the inner surfaces of the first and second substrates.

In some configurations, the at least one interlayer comprises a polymer selected from PVB, TPU, EVA, silicone, ionomers and COP.

In some configurations, the at least one interlayer is ≥0.1 mm and ≤6 mm thick.

In some configurations, the at least one interlayer comprises PVB and a plasticizer.

In some configurations, the interlayer comprises a dye, a pigment, a uniform thickness, a continuous layer, a non-uniform thickness, a separator and an acoustic material.

In some configurations, the inner surface of at least one of the first substrate and the second substrate are one of uniform, non-uniform, planar and bent.

In some configurations, the laminate further includes a component embedded between the inner surfaces of the first substrate and second substrate.

In some configurations, the at least one substrate is formed from pellets printed onto the inner surface of one of the first and second substrates.

In another aspect of the disclosure, the disclosure is directed to a method of forming a laminate comprising: providing a first substrate having an inner surface and an outer surface; providing a second substrate having an inner surface and an outer surface; printing a first interlayer defining a first outer boundary on at least a portion of the inner surface of at least one of the first substrate and second substrate; printing a second interlayer defining a second boundary on at least a portion of the inner surface of the at least one of the first substrate and second substrate, wherein the first outer boundary and the second outer boundary are spaced apart from each other; positioning the first substrate over the second substrate so that the inner surface of the first substrate faces the inner surface of the second surface so as to sandwich the at least one interlayer therebetween; pressing the first and second substrates so that at least a portion of the first boundary layer contacts the second boundary layer which were spaced apart from each other prior to pressing.

In some configurations, the first interlayer encircles a portion of the inner surface of at least one of the first and second substrates to define an encircled portion, and wherein the second interlayer is positioned with the encircled portion.

In some configurations, a portion of the first boundary is separated from a portion of the second boundary so as to form a void in the step of pressing.

### BRIEF DESCRIPTION OF THE DRAWINGS

Reference herein will be made to drawings wherein:

FIG. 1a shows a top view of an interlayer printed a substrate;

FIG. 1b shows a cross-sectional view of a laminate or prelaminated with a second substrate placed on the printed interlayer and, preferably, at least partially pressed out on the interlayer;

FIG. 1c shows a cross-sectional view of laminate that has been processed, wherein such processing can be achieved, for example by heating and pressing in a vacuum chamber, or otherwise pressed out.

FIG. 2a shows a top view of an interlayer printed a substrate, in an second pattern;

FIG. 2b shows a cross-sectional view of a laminate or prelaminated with a second substrate placed on the printed interlayer and, preferably, at least partially pressed out on the interlayer;

FIG. 2c shows a cross-sectional view of laminate that has been processed, wherein such processing can be achieved, for example by heating and pressing in a vacuum chamber, or otherwise pressed out.

### DETAILED DESCRIPTION OF THE DISCLOSURE

While this disclosure is susceptible of embodiment in many different forms, there is shown in the drawings and described herein in detail a specific embodiment(s) with the understanding that the present disclosure is to be considered as an exemplification and is not intended to be limited to the embodiment(s) illustrated.

Many types of interlayer materials, resins and/or polymeric materials may be printed as an interlayer or as a stack of layers to form an interlayer. PVB is a well-known polymer for use in making films or sheets often referred to as interlayers for safety glass, glass-glass, glass-plastic and all plastic laminates of all kinds including commercial, residential, transportation and bullet resistant window products. PVB is a preferred material for printing one or more layers of an interlayer of this invention. Also preferred are materials well known for use as interlayer materials like thermoplastic polyolefins, (TPO), cyclic olefin polymers, (COP), cyclic polyolefin copolymers, ethylenevinylacetate, (EVA), thermoplastic polyurethanes, (TPU), silicones and ionomeric polymers systems including polyethylene-co-methacrylic acid especially when the acid functionality of the ionomer is neutralized or partially neutralized with, for example, lithium, sodium and/or zinc. Also preferred are plastic materials that may be printed in layers that are often used to provide special properties within interlayer stacks including separator properties between other interlayer materials. These plastic materials include polyethylene terephthalate, (PET), PETG, polyethylene naphthalates, (PEN), nylons, polyvinylchloride, polyvinylidene chloride, polyvinylidene fluoride, polycarbonate, certain acrylics and again cyclic olefins and cyclic olefin copolymers. Thermoset materials including two component systems and/or latent crosslinking materials and systems, like certain types of EVA or polyurethanes, may also be printed as the interlayer or part of the interlayer of the present disclosure. [0030] The printing of interlayers preferably involves direct deposition on substrates of thermoplastic material with optional additives and plasticizers included in the strand, filament or pellets of polymer or resin material being printed. The printing may also involve a meter mixed composition of two or more materials. The printing system may monitor and control flow rates for single and multiple materials through the print head. The printing system may involve liquid injections and/or side stuffing of materials into a solid or molten resin stream in the print head or extrusion head prior to the actual printing or deposition of interlayer material onto the substrate. In some cases, it is preferable for the printer to include means of determining the distance and controlling the distance between the print head(s) and the substrate or previously printed layers of interlayer material, wherein the means is some type of distance measuring sensor or the like including the use of an interferometer. This is especially useful for better control of the distance between the dispensing end of the print head and the surface being printed. Controlling this distance in many instances allows for improved control or adjustments in the “z” direction or direction perpendicular to the substrate for more accurate printing especially when there are variations in the thickness or flatness of the substrate or of the previously printed layer. This can be of particular importance when the substrate is non-uniform or is a bent sheet of glass like that used, for example, in windshields or sunroofs. Printing interlayers allows a uniform interlayer to be built up on or around non-uniform substrates or components on or in substrates especially when measurement or imaging capability is built into the printing system.

Each strand, filament or profile deposited on a substrate will preferably be between about 0.05 and about 3 millimeters thick and a series of layers formed by the printing process will preferably be between about 0.2 and about 6 millimeters thick, while of course other dimensions for each are contemplated, and these are considered to be exemplary. The area of the printed interlayer may be quite small but may be as large as about 3 meters by about 6 meters or more. Printing may be considered a slow process but print heads may move fast and anywhere from one to two to dozens of print heads may be ganged together and many strands, filaments or profiles may be printed in each pass. An entire layer of interlayer may be printed in just one, two or several passes over the substrate. In some cases, an entire interlayer may consist of a single printed layer but often two or more layers will be printed. A layer of stands, filaments or profiles may be deposited or oriented in the same direction or some area covering pattern may be used to increase speed of print coverage. Subsequent layers of strands, filaments or profiles may be printed in the same direction or they may be printed or deposited in different directions such as a cross hatch type pattern or for instance at 90-degree or for instance at 45-degrees relative to the orientation of strands of the previously printed layer of interlayer. However, it may often preferable, at least on a macroscopic scale, for the strands, filaments or profiles to coalesce or meld into a uniform layer, sheet or film either during printing or during subsequent laminate processing.

A print head or a set of print heads may move across a substrate. The print heads are typically mounted on a beam that moves across the bed with a substrate typically registered and held in place on the bed. While the beam moves in one direction the print heads may move along the beam in a second direction and either the heads, the beam or the bed may move in the third direction. This or other known methods give full three to six axis control for the printing process. Other beams with additional print heads may be included in the printer assembly. Alternatively, the substrate or bed may also be moved or translated in one or more of the x, y and z directions passed a fix print head or set of heads or print heads limited to movement in one or two directions. Fixed position print head(s) allow, for example, spools of strands or filaments of interlayer material being fed into the print heads to remain stationary as well as the heads themselves. Preferably the positioning or movement of the head or the substrate will use G-code type programming although the printing functions themselves may involve M-code programming. Of course, the disclosure is not limited to any particular print heads, or quantity of print heads or method of programming.

The substrates onto which the interlayers materials are printed may be any type of glass, ceramic, glass-ceramic or plastic sheet material. Substrates may be flexible like for example a PET film, conductive coated PET film, multiple layer films of alternating index of refraction, thin polycarbonate, thin acrylic, ultrathin glass. An interlayer printed on such a flexible substrate may be rolled up and shipped globally. Optionally the printed interlayer may be removed from the flexible substrate and placed between other glass and/or plastic substrates. Optionally, the flexible substrate can remain with the printed interlayer and be used to prepare complex interlayer composites or laminates. Optionally interlayer can be printed on both sides of a flexible substrate and optionally the flexible substrate can become part of the final laminate. Substrates may also involve other materials to be laminated like solar panels and interlayer materials may be printed on solar panels or solar cells or substrates to be bonded to solar cells. Printing or essentially “overmolding” on an array of components like solar cells with interlayer material has the significant advantage that interlayer material may be printed between as well as on or over the components and more readily fill gaps and interstitial spaces. This along with printed edge seals improves durability by providing a better seal to the cells or components and barriers to the environment. The substrates may be flat like a commercial and residential window or bent like, for instance, a windshield, sunroof or other transportation window. When printing on a bent substrate it is preferable to use a printing system wherein the printer is capable of determining and controlling the distance between the substrate and the dispensing end of the print head(s). During the printing process the substrates may be at room temperature or above or below room temperature. Often the substrate is heated to between about 40 C and about 140 C to promote adhesion of the interlayer materials to the substrate as it is printed and to promote the melding to each other of individually printed strands. In some cases, a heated substrate is preferred to provide some relaxation or stress minimization of the interlayer material as it is being printed. Adhesion to the substrate may also be improved by printing or coating the substrate with a primer or a tie layer prior to providing the interlayer.

Printing a layer of interlayer material onto at least one substrate may be done prior to forming a laminate with another substrate subsequently placed in contact with the interlayer that was formed by printing. Alternately, interlayer materials can be formed by printing onto two different substrates and a laminate may then be formed by bringing the printed interlayers into contact, sometimes followed by subsequent processing. Alternately, an interlayer material may be printed on one substrate, the same or a different interlayer material may be printed on a second substrate and a tie layer may be printed or coated on one or both of the printed interlayers. With the tie layer, a laminate may be formed by simple nip roll tacking or with other minimal processing or heating after some type of tacking process. Printing on both substrates may provide air free or nearly air free interfaces between each substrate and printed interlayer and the tie layer may allow an air free bond to form between the interlayers with minimal processing. The tie layer may be a low molecular weight version of the interlayer material, a plasticizer including a solid plasticizer, a highly plasticized material including a highly plasticized version of the one of the interlayer materials, a contact adhesive, a low melting solid or some other low molecular weight materials compatible with the interlayer materials. Alternately a layer of interlayer can be formed by printing on one substrate and a second layer of interlayer is provided as a preformed sheet or film. Alternately one or more than one type of interlayer material can be formed by printing onto two different substrates and a film or sheet such as, for example, a separator material is provided between the printed interlayer materials and substrates, the substrates, printed layers and separator are all bonded together to form a laminate. Alternately a special interlayer material like, for instance, adhesion inhibited interlayer materials may be printed on both glass substrates of a windshield and a conventional or special sheet of interlayer may be bonded to the printed interlayers and between the substrates to form a laminated windshield.

The substrate temperatures and temperatures of the deposited strand, filament or profile are chosen to promote uniform adhesion of the interlayer material to the substrate, the adhesion and desirable interfacial properties between individual strands, filaments and profiles as they optionally butt up against each other and the adhesion and interfacial properties of optional subsequent layers to the previously deposited layer. The composition of the interlayer material, regarding resin properties, plasticizers and additives, can be chosen so as to allow, in some cases, for a uniform, relatively homogenous film or final interlayer to be built up from the deposition of many strands of one or more printed layers of interlayer material. When necessary, subsequent processing of laminates in a vacuum bag, vacuum platen laminator, an autoclave, oven or kiln may be helpful in making the printed interlayer into a homogenous film and the laminate one of good optical quality and resistant to pummel and impact. A particularly advantageous process has been discovered whereby thick profiles of interlayer material are printed on a substrate in a short time in an array or pattern that only covers about half or one third or even one quarter of the area of the substrate. A perimeter seal is provided of interlayer material or some other material as an edge sealant. A second substrate is provided and the assembly is processed in a vacuum lamination process such that at least a complete edge or perimeter seal is formed between the substrates and a vacuum or substantially reduced pressure is captured in the assembly in what may be called a tacking process. Particularly effective in at least tacking the laminate is processing in a VPL. Interestingly, subsequent processing at elevated temperatures allows the interlayer material to flow into all or most of the void space/volume and a boundary is formed where individual printed areas meet. With enough time at elevated temperature this boundary or interface may coalesce allowing the interlayer material(s) to form a substantial uniform layer. After vacuum tacking, the subsequent processing may take place with the assembly at atmospheric or elevated pressure such as in an autoclave.

There are a number of advantages to the processes and configurations as disclosed. For example, an advantage of printing interlayer materials on more than one substrate to be used in the final laminate is that each printed interlayer material may form a uniform, well bonded and air free contact to the substrate. If the interlayer materials printed or deposited on two substrates are brought into contact such that the interlayer materials contact each other, an air free or nearly air free contact between the interlayer materials may be formed in a nip roll process where the substrates and interlayer materials are optionally heated. The printed interlayer may be smooth or optionally may have a surface texture to assist in the deairing process. Alternately the interlayer materials may be brought into contact and bonded to each in an air free or nearly air free manner by various vacuum tacking or vacuum lamination processes with optional heating in during the process. When the interlayer materials, the printing or deposition processes and the tacking process are properly chosen a finished laminate may be formed without further processing or by further processing that only involves an oven or kiln at atmospheric pressure and avoids a costly autoclave process or operation.

Although printed interlayers are often uniform in thickness, in some cases the deposited or printed interlayer may be intentionally non-uniform, for example, in the case of a wedge-shaped interlayers that are useful in windshields with heads-up displays. Printing is advantageous in terms of flexibility to handle complex patterns or change from one pattern to another pattern. This would be the case, for example, for the printing special materials for heads-up displays in one area and then printing the tint band of a windshield and/or a darkened-out pattern for solar protection of underlying objects like rearview mirrors, header consoles and display systems in other areas and still other areas with good transmission for cameras, sonar and other detection systems.

Specialty interlayers sometimes involve or incorporate special materials, systems and/or expensive additives like thermochromic, electrochromic, photochromic, acoustic, phosphorescent, fluorescent, lower critical solution temperature, thermoscattering and/or decorative materials and systems. High yield and minimizing and/or avoiding trim waste in making laminates may be especially important with these and other expensive additives and the interlayer formulations that incorporate them. In such configurations, printing these interlayers may provide a cost savings and, in some cases, improved quality and durability.

Another advantage of printing interlayers on substrates is that the substrates may already be placeable in a printer for other processing. The substrates may be pre-printed with, for example, adhesion promoting materials like silane and/or other coupling agents, adhesion inhibitors like those used in the windshield manufacture or a pattern of inks or pigments that may be anywhere from a low resolution to a very high resolution pattern. Alternatively, or additionally, any number of materials may be printed on an already printed interlayer and then optionally printed over by more interlayer material.

In some cases, there is a desire for a particular color or multiple colors in an interlayer material itself. Printing of the interlayer material makes possible printing of several colors by switching print heads or by having multiple print heads with different color resin materials or having multiple stands of different materials selectively fed at different times into a single print head. With three primary colors of interlayer materials that may be printed, either additive with red, green and blue or subtractive with yellow, cyan and magenta, it is possible to produce a wide palette of colors. Three layers of different colors and thicknesses may be printed uniformly over one or more substrates to achieve virtually any color for light traveling through the composite of the layers. Different colors may be selectively printed next to each other or selectively overlaying each other in several layers to give virtually any color appearance in any given spot. With the use of primary colors, along with the use of a colorless material, there are nearly endless possibilities for multicolor patterns when a dot pattern is printed or two or more printed layers are stacked on each other. Full color picture printing is possible with just the printing of an interlayer or interlayer stack. The colored interlayer materials may be produced with dyes which allow for some or substantial transmission of light or they may be produced by pigments which block light transmission substantially or entirely in certain areas. A combination of light blocking, and light transmission materials may be printed to give a wide variety of effects and appearances. By printing in two or more passes over a substrate area, the layers of the multilayer stack provide other benefits, like the first layer printed may have excellent UV absorbing properties and thus protect the subsequently printed layers from UV exposure especially chromogenic material or dye containing layers. [0041] A simple example of a tinted pattern in a laminate with printed interlayers involves a clear, colorless layer of PVB or TPU with excellent UV absorbing properties about 0.28 millimeters thick printed over nearly the entire area of a glass sheet substrate. Then a multicolor pattern of PVB or TPU is printed in two or three layers with clear, colorless interlayer material and three different colors of interlayer material printed with 4 different print heads in selected areas of each layer to form, for example, a picture or a corporate logo in a relatively uniform layer with an overall thickness of about 0.2 millimeters over nearly the entire area of the initial 0.28 millimeter thick clear, colorless layer. Then another clear, colorless layer of PVB or TPU about 0.28 millimeters thick may be printed over nearly the entire area of a second glass sheet substrate about the same size as the first glass sheet. The printed interlayers are brought into contact with each other with the glass sheets registered to provide maximum contact between the layers of interlayer. This laid-up, prelaminate is heated to about 30 C and passed through a first set nip or pinch rollers and then it is heated to about 65 C and passed through a second set of nip or pinch rollers. This laminate is optionally further processed in an oven, kiln or autoclave at elevated temperature to finish the lamination process. This laminate, when installed in a building with the first printed interlayer facing outboard, will have a UV protected, colored pattern with an overall interlayer thickness of about 0.76 millimeters.

Colorless and tinted layer(s) may be printed and built up in some areas and other colorless and tinted areas may be printed and built up in other areas as the thickness of multiple layers are printed to form an overall interlayer. This has the possibility to produce a depth or three-dimensional appearance to the patterns in the interlayer as the tinted areas are and appear to be at different depths in the interlayer. This three-dimensional appearance may become even more dramatic when multiple printed interlayers are separated by substrates like sheets of glass or plastic. For example, a multilayer laminate might involve a sheet of glass or plastic, a printed, patterned interlayer, a second sheet of glass or plastic, a printed, patterned interlayer and a third sheet of glass or plastic. Any number of substrates and interlayers may be stack and formed in a laminate in this manner. In these cases the printed patterns in the laminate exhibits a three-dimensional effect since the patterns are at different depths in the laminate. These laminates can, in many instances, also exhibit superior impact and penetration resistance including some level of bullet and blast resistance.

Printing the interlayer material may be advantageous for printing multiple layer interlayers like thermochromic interlayers where one thermochromic layer tints with increasing temperature with increasing absorption of a first portion of the sun's spectrum and a second thermochromic layer tints with increasing temperature with increasing absorption of a second portion of the sun's spectrum. Two, three or more thermochromic layers may be printed, and separator layers may be provided as separate layers or may be printed as intervening layers directly. By printing thermochromic interlayers, the layers may be produced with less stress and shear as an extrudate of printed material as compared to normal film or sheet extrusion of the thermochromic interlayers and thus these printed thermochromic interlayers may have higher performance and durability in addition to lower cost due to less waste.

Other multilayer interlayers that may be printed are all or a portion of sound insulating or acoustic interlayer, special impact resistant interlayers along with printed plastic or polymer layers to form parts of laminates that are bullet and/or blast resistant.

The printing of the interlayer material provides an opportunity for alignment of the polymer chains as they flow through the print head or extruder. Optionally, this alignment can be provided when the interlayer thickness is built up by two or more passes where all alignment may be in one direction or the printed strands, filaments or profiles of interlayer material are crosshatched, spiderwebbed or put down in any multiple directional pattern to provide increased elasticity, strength and/or elongation before breaking. The flow of the interlayer materials through the print head or extruder also allows for preferential alignment of materials and particles dispersed, distributed or dissolved in the resin material like liquid crystals, nanoparticles, decorative flakes, directionally light scattering particles, quantum dots and virtually any disbursed or distributed anisotropic particle, disc shaped particles, elliptical shaped particles or any material impacted by the flow of the resin being printed. The print head configuration may also be designed as a slot, rectangle, circular, oval, ellipse, non-uniform or multi-orifice pattern to assist in preferential orientation of the extrudate or materials disbursed or distributed in the extrudate or printed material.

It is preferred in some configurations to print interlayer material from strands, filaments or pellets of interlayer material fed into the print head or dispenser. It is preferred in some configurations to print the interlayer materials as strands, filaments or profiles coming out the print head or dispenser. Alternately the interlayer materials may be printed as droplets, pillars or columns. Generally the printed interlayer is at least somewhat light transmitting and can be used to form a laminate by substantially bonding substrates together.

In some cases, for high speed printing, the print profile for the interlayer materials is quite large, like say 0.5 millimeter to 6 millimeters thick or wide, then when the printer is turned around to print the next row, the printed materials flow or twist in an awkward manner. This challenge is addressed by allowing the interlayer material to be printed off the edge of substrate and this small overhang of material may, optionally, be trimmed off at some later stage before or after further processing into a laminate. Alternately in this case or in any of the cases of printing interlayer the feed of interlayer material may be halted and/or there may be some retraction or suck back of interlayer material to allow a cleaner turn around. Alternately in this case or in any of the cases of printing interlayer the printed head may be allowed to cool or the head may be actively cooled to allow flow to be interrupted and in some cases a clean break of strands, filaments or profiles is achieved momentarily and then flow is resumed when further printing is desired. Alternatively, the print head may contain a mechanical shut off valve or cleavage capability to assist in the start stop process.

After printing the layer or layers or between printing of layers the printed layers or interlayer may be mechanically polished, machined, rolled, smoothed, flame treated, flame polished, heat treated, treated with exposure to electromagnetic radiation, crosslinked or texturized to enhance the lamination process or properties of the interlayer or the laminate using the interlayer. The printed interlayer generally involves printed thermoplastic materials but may include materials that have latent crosslinking capability. The printed interlayer may utilize curable or thermoset layers by themselves or as part of a multilayer stack involving other thermoset material and/or thermoplastic layers printed on a substrate.

The printing of interlayer allows for the ready incorporation of a printed or otherwise applied edge seals that protects the interlayer. The edge seal may be applied or printed before, during or after the printing of the interlayer material. The edge seals are typically applied or printed around the perimeter of the substrate but may also be applied or printed around holes or opening cut into a substrate for things like point suspension connectors or hardware or the hardware for doors or office walls and/or panels. Edge seals can be of interest when the interlayer incorporates special materials like chromogenic, acoustic, phosphorescent, fluorescent, liquid crystals, nanoparticles, directionally light scattering particles and/or quantum dots materials and systems.

The interlayers may be printed in forms that assist in positioning and embedding of components such as solar cells, displays, touch screens, decorative components, point suspension or mechanical connectors or electrical connectors or spaces for conduits, raceways, wires or electric connectors. Printing a pocket or void for embedded components is significantly more precise than cutting a pocket or void in a conventional sheet or film of normally extruded interlayer as these films may shrink once cut and may shrink differently in machine vs transverse direction. This shrink and possible distortion of the cut shape makes bubble or air free embedding in the final laminate structure quite difficult. The pocket or void for embedding may be printed directly on a substrate, on a thin interlayer may first be printed on the substrate or on a conventional free standing film or sheet of interlayer laid on the substrate. The component, material or item to be embedded may be placed in the pocket or void and coated or overmolded with printed material or covered with a conventional free standing film or sheet of interlayer prior to placement of a second substrate to form a prelaminate. Particularly advantageous is the placement of the component on the substrate or initial layer of interlayer and then printing the component into the interlayer including optional print of the interlayer material butted up against the component. Printed interlayers and/or associated edge seals may be thermally and/or electrically conductive or may incorporate thermally and/or electrically conductive materials. Electrically conductive materials may be used to make contact to components or conductive coating on the substrates including transparent conducting layers on the substrates to provide or enhance buss bars and electrical connections. This may be useful for certain technologies incorporated into laminates like heating, touch sensing, dynamic, switchable and other electro-optic systems and light emitting materials and systems. These include electrochromic, suspended particle devices, polymer dispersed liquid crystals, polymer stabilizer cholesteric texture, bi-stable ion doped semetic liquid crystal layers, heated glass, light emitting diodes and electroluminescent materials and technologies. Printed interlayers may contain or may be intumescent materials for use for example in fire rated windows. An edge seal material may be printed around or near the perimeter of the laminate to contain or protect the intumescent materials once the laminate is formed.

Materials to be printed may contain adhesion promoting materials like silanes, tackifiers or coupling agents, adhesion inhibiting materials like oils and/or salt, plasticizers, all types of stabilizers, all types of dissolved and/or dispersed light absorbers including UV, visible and/or NIR absorber and x-ray and ionizing radiation absorbers.

Printing interlayer materials provides a manner of printing of patterns of fluorescent, phosphorescent, UV absorbing, UV, visible and/or NIR reflecting materials, dissolved or dispersed in the interlayer. This includes patterns for use in a bird friendly pattern that helps with bird strike avoidance. UV reflecting capability is provided by, for example, a dielectric mirror stack tuned to reflect selectively in at least part of the range of UV between 310 nm and 400 nm. In one embodiment the reflector stack is provided as small flakes of reflector material or reflector material on flakes of a clear carrier like ultrathin glass or plastic. These flakes are dispersed in an interlayer resin material and are printed and are preferably printed such that the flakes have at least some preferential orientation that promotes UV reflection at least somewhat in a direction perpendicular to the surface of a window that incorporates the interlayer. If at least the first printed layer of the interlayer is printed on a UV transmitting substrate like soda-lime glass and the laminate that incorporates the glass substrate and the interlayer are part of a laminated windowpane and the window pane is oriented so this printed pattern faces outboard, birds with enhanced ability to see in the UV can see the pattern and be deterred from flying into the window.

Printing interlayer also allows for the purposeful introduction of permanent voids into the interlayer structure. The interlayer may be printed in a hexagonal or honeycomb pattern and/or a similar pattern of circles, ellipses, triangles, squares, rectangles and/or a combination thereof. The structure is printed in a pattern that rises largely perpendicular from the surface of the substrate on which it is printed. The printed structure has enough printed area to provide for bonding to a second substrate and for enough strength to provide structural integrity to the final laminate.

These permanent voids in the interlayer structure may be filled with inert and/or low thermal conductivity gas or gasses like argon, kryton, sulfur hexafluoride or carbon dioxide. This may be accomplished in a VPL process where in the VPL is pressured or back filled after the vacuum cycle with low thermally conductivity gas prior to tacking or pressurized with low thermal conductivity gas through a porous edge seal after tacking, in which case the edge seal is plugged on removal from the VPL. The voids may be filled with aerogel or similar light transmitting, thermally insulating materials that are themselves filled with air, inert gas, vacuum or reduced pressure gas. Even without any fillers, the voids may be evacuated to provide low thermal conductivity between the windowpanes as long as they are not heated passed the point where the interlayer material will flow into the voids. In the case of evacuation, the laminate may be formed by a vacuum lamination process like a vacuum bag process or a vacuum pressure laminator and the printed interlayer in this case has the strength and structural integrity required to withstand atmospheric forces on the outside of the laminate. Edge seals may be provided during the formation of the laminate or after the laminate is formed. Edge seal are effective to maintain vacuum in the laminate long term.

The voids may extend from one substrate to the next and/or the voids may be interrupted with thin layers of the interlayer material suspended in the gas or vacuum space. The interruption may be thin films, fibers or stands of interlayer material which in some cases appear like cobwebs or gauze. Many of the interruptions are positioned at least partially parallel to the substrates to interfere with the thermal conduction between the substrates by the atoms and/or molecules of gas even the very few atoms and/or molecules of gas in a low gas pressure or near vacuum condition. During printing, the interruptions may be thin printed films positioned mostly as horizontal layers bridging between the vertical pattern or structure of material that is largely perpendicular to the substrates. In the case of vacuum lamination, the thin layers parallel to the substrates are slightly porous or perforated to allow uniform evacuation. When the laminate has vacuum voids within the printed interlayer structure, there is preferably enough interlayer material parallel to the substrates to interfere with conduction from residual gas and enough interlayer that is largely perpendicular to the substrates to prevent collapse of the interlayer when the laminate is in normal atmospheric conditions. The printed patterns both perpendicular and parallel to the substrates may be chosen to maximize overall visible light transmission while minimizing light scattering. However, windows with these permanent void containing interlayers are typically not used as view window but as high thermal insulation, daylighting windows like clearstory windows, building roof panels and panoramic roofs for vehicles. These laminates, interlayers and windows may incorporate solar control technologies like low-e coatings, UV, visible and NIR reflectors, NIR absorbers including NIR absorbing nanoparticles, UV absorbers, visible absorbers and/or thermochromic materials including any of these materials in the printed interlayer materials.

The laminates of the disclosure may involve any number of the substrates bonded together with interlayers wherein at least one of the interlayers is printed.

### DRAWINGS

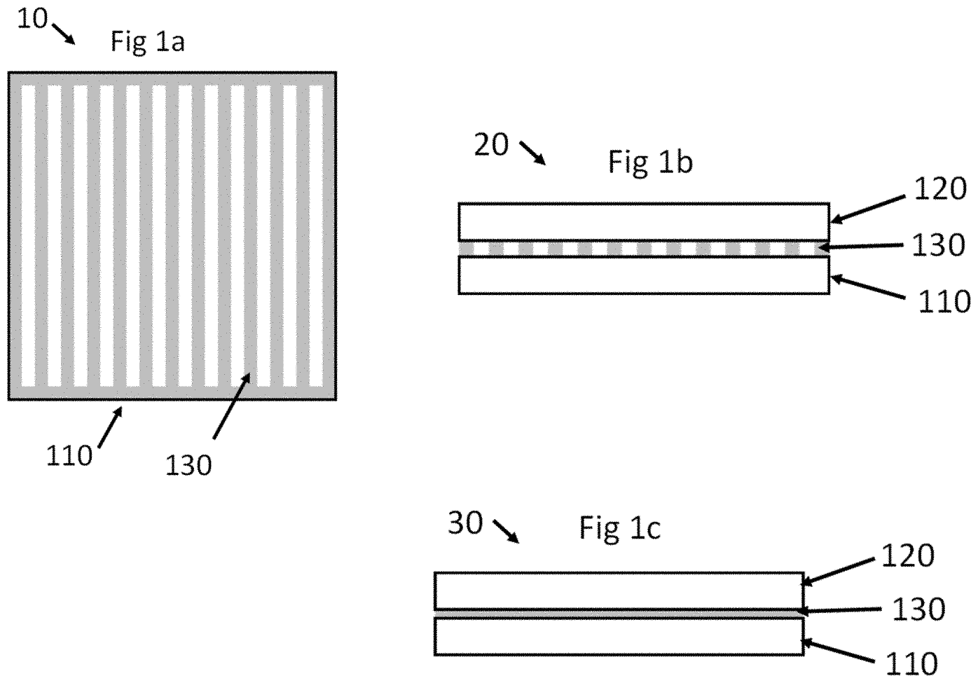

FIGS. 1a-c illustrate a laminate prepared by printing a portion of the area of substrate. This is followed by a tacking or vacuum tacking process and optional subsequent processing.

More particularly, FIG. 1a shows a top view, 10, of an interlayer printed a substrate. The substrate, 110, is printed with interlayer material, 130, in a pattern of lines that are extra thick and spaced apart. Generally, the printed interlayer also has a continuous perimeter of printed material at least as thick or thicker that the printed lines. Printing thick lines over only a portion of the substrate speeds the printing process.

FIG. 1b shows cross-sectional view of a laminate or prelaminated, 20, with a second substrate, 120, placed on the printed interlayer and pressed out on the interlayer material, 130, to some extent. This can be in a vacuum lamination process or in a process that provides a low thermal conductivity gas in the volumes devoid of interlayer. The laminate, 20, may be used as is for certain applications, especially when the void volumes contain a low thermal conductivity gas like argon or krypton.

However, if the prelaminate, 20, is properly tacked in a vacuum tacking process like a VPL process the prelaminate may be processed further into a laminate, 30, like that shown in the cross-sectional view in FIG. 1c. This can be achieved by heating and pressing in a vacuum chamber or after vacuum tacking by subsequent heating at atmospheric or elevated pressures such as in an autoclave. Remarkably if the volumes devoid of interlayer contain significant vacuum the interlayer material can flow to a boundary created by the meeting of separate portions of the interlayer material. Generally, the interlayer materials will further coalesce at this interface and substantially fill the voids to form a substantially continuous layer of interlayer.

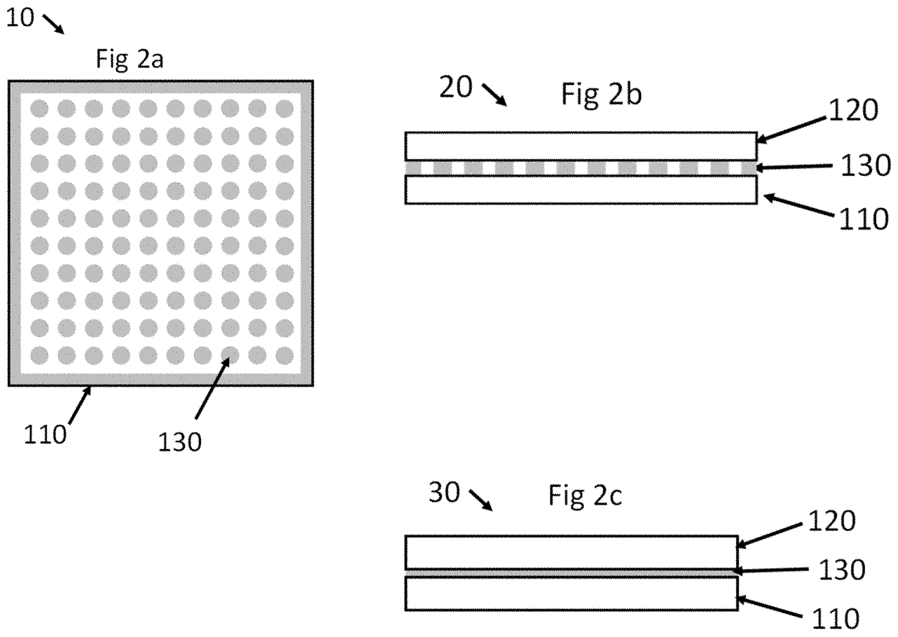

FIG. 2. illustrates a laminate prepared by printing a portion of the area of substrate in an alternate pattern to FIG. 1. Here a series of dots or circles is used but many patterns are possible including one or more dog-bone shaped printed area of interlayer. Otherwise, the description for FIGS. 1a-c apply to FIGS. 2a-c. as well and, like reference numbers are utilized for like structures in FIGS. 2a-c.

Furthermore, while the interlayers may be printed as continuous or near continuous layers, FIGS. 1a-c and FIGS. 2a-c show how the interlayer may be printed in non-continuous forms to provide laminates with non-continuous interlayer or continuous interlayers by special processing. Figures are for illustration purposes and details are understood to not be to scale.

### Experimental

Interlayers printed from filaments onto substrates and subsequently used for making laminates included clear TPU, black TPU, clear PVB, clear PVB with plasticizer, PVB with a thermochromic system that tints to darker and darker blue as the temperature of the interlayer increases, PVB with a thermochromic system that tints to darker and darker orange as the temperature of the interlayer increases, polyvinylacetate, and polyethylene terephthalate glycol-modified, (PETG).

Also printed from filament were clear acrylic, clear polycarbonate, black polycarbonate acrylonitrile butadiene styrene, (ABS). These materials were used as separators, functional layers, edge seals, inlays and decorative figures. Interlayers printed from pellets fed into a print head and onto substrates included polyolefins, PVB with a thermochromic system that tints to darker and darker blue as the temperature of the interlayer increases, PVB with a thermochromic system that tints to darker and darker orange as the temperature of the interlayer increases.

### EXAMPLES

Example 1. A single layer of PVB interlayer was printed with a Creality Ender-3 printer starting from a roll of 1.75 millimeter diameter filament of PVB supplied by Polymaker. The PVB was printed as a series of heat-fused strands onto an about 2.2 millimeters thick sheet glass that was heated to about 100 C during the printing process. The print head temperature was set to about 225 C. While the printer nozzle was circular, the PVB strand profile printed was nearly rectangular and was about 0.03 millimeters thick and about 0.4 millimeters wide. These printed, rectangular profiles butted up against each other to form a continuous film about 0.03 millimeters thick. In this example an area about 125 millimeters by about 125 millimeters was printed with a continuous interlayer film in about 30 minutes and the printed interlayer film adhered well to the glass.

Example 2. Two layers of PVB interlayer were printed with a Creality Ender-3 printer starting from a roll of 1.75 millimeter diameter filament of PVB supplied by Polymaker. The PVB was printed as a series of heat-fused strands or profiles onto an about 2.2 millimeters thick sheet glass that was heated to about 100 C during the printing process. The print head temperature was set to about 225 C. While the printer nozzle was circular, the PVB profile printed was nearly rectangular and was about 0.015 millimeters thick and about 0.4 millimeters wide. The profile of the strands of the second layer were printed at an angle of 45 degrees to the strands printed for the first layer. In this example an area about 125 millimeters by about 125 millimeters of PVB interlayer was printed in about 60 minutes and the resulting interlayer formed an air free interface that was well adhered to the glass.

Example 3. A sheet of glass was printed with interlayer in the same manner as in Example 2. The printed sheet of glass from Example 2 was placed over this second sheet of glass with the printed interlayers facing and contacting each other. The overlaid sheets of glass were placed in a reusable silicone vacuum bag and a vacuum was used to produce a pressure of less than 1 torr inside the bag. The bag was placed in a convection oven for about 16 hours at 110 C. A portion of the interlayer films bonded together to form a clear interlayer and thus a clear laminate in that portion of the laminate.

Example 4. Six layers of PVB interlayer were printed with a Creality Ender-3 printer starting from 1.75 millimeter diameter filament of PVB supplied by Polymaker. These layers were printed as a series of heat-fused strands onto a sheet glass about 2.2 millimeters thick that was heated to 100 C during the printing process. The print head temperature was set to 225 C. While the printer nozzle was circular, the PVB print profile coming out of the print head ended up nearly rectangular as it was deposited and was about 0.12 millimeters thick and about 0.4 millimeters wide. These printed, rectangular strands butted up against each other to form a continuous layer about 0.12 millimeters thick. The six layers resulted in a continuous interlayer about 0.72 millimeters thick. The layers of PVB were printed in a pattern that left a perimeter of about 10 millimeters wide unprinted. Also, the PVB was not printed in areas that made up a pattern of letters in the view area of the glass sheet. After the PVB interlayer was printed, the printing material was switched to 1.75 millimeter filament of black ABS from Amazon Basics. The ABS material was printed onto the same about 2.2 millimeters thick glass sheet in the pattern of letters that was left as voids in the printing of the PVB interlayer. ABS was also printed in the 10 millimeter strip on the glass around the entire perimeter of the printed PVB to form an ABS edge seal that was 0.72 millimeters thick. Also, ABS was printed about 0.4 millimeters thicker in 10 millimeter by 10 millimeter pillars or standoffs in each corner and on the edge seal in the center of each side between the corners. These raised areas in the edge seal served to allow better de-airing of the interlayer when a second sheet of glass was placed on the pillars or standoff to form a prelaminate. The prelaminate was placed under vacuum in a reusable silicone vacuum bag and was completely de-aired before the temperature was raised. On heating the ABS in the pillars flowed out and the second sheet of glass came uniformly into contact with the interlayer, the edge seal and the printed letters. After 4 hours under vacuum with the vacuum bag in an autoclave at 140 C and a pressure of about 1 megapascal, the glass sheets were uniformly bonded to the PVB interlayer, the ABS letters and the ABS perimeter edge seal. The laminate exhibited good visibility through the PVB and high contrast for the black letter pattern and black perimeter edge seal.

Example 5. Precision thickness thermochromic PVB filaments was produced by a two-step process. First thermochromic formulations were extruded with liquid injection of some of the components and powder feed of the PVB and optionally other components into a conical twin screw extruder with a liquid injection port on the side of the extruder. In each case, a stand of extrudate was fed into a pelletizer and chopped into fine pellets. The pellets were dried in a vacuum chamber over activated desiccant at room temperature. In each case, the pellets were then fed into a single screw extruder with a strand die and excellent gauge control for the filament produced. The filament was rolled up onto large spools and dried again under vacuum over desiccant. A thermochromic filament that tinted to darker and darker blue was produced in one case and a thermochromic filament that tinted to darker and darker orange was produced in another case.

Example 6. A precision thickness thermochromic filament from Example 5 that tinted to darker blue was printed with a Modix Big60 on an about 3 millimeter thick glass substrate about 56 centimeters by about 56 centimeter in area. This thermochromic interlayer was printed in two passes to give a total thickness of about 0.8 millimeters. A second about 3 millimeter thick glass substrate about 56 centimeters by about 56 centimeter in area was printed using the Modix Big60 printer and a precision thickness thermochromic filament from Example 5 that tinted to darker orange. The orange tinting interlayer was about 0.4 millimeters thick. A sheet of PET about 0.13 millimeter thick about 56.5 centimeters by about 56.5 centimeter in area was placed between the two thermochromic interlayers and the assembly was placed in a vacuum bag. A vacuum was applied and the assembly in the bag was heated to about 110 C for about 90 minutes. On removal a uniform clear laminate was formed with the structure glass/orange tinting interlayer/PET/blue tinting interlayer/glass. This laminate was assembled as the outer pane a double pane window with a triple silver low-e coating on the inner pane of glass with the low-e facing the air space of the insulated glass unit. This resulted in a sunlight responsive, gray tinting dynamic window glass unit that provided excellent solar heat gain control on installation in a building with the thermochromic laminate facing the outside of the building.

Example 7. A precision thickness red tinted PVB filament was produced by extruding PVB powder with liquid injection of a plasticizer with red dye dissolved in it with a conical twin screw extruder. This produced non-precision filament that was fed into a pelletizer where it was chopped to fine pellets. The pellets were dried under vacuum over activated desiccant in a chamber at room temperature. These pellets were then fed into a single screw extruder with a strand die and excellent gauge control for the filament produced. The filament was rolled up onto large spools and dried again under vacuum over desiccant. This filament was used to print an interlayer pattern on a glass substrate with a continuous perimeter of interlayer material about 0.8 millimeters thick and a series of lines about 0.8 millimeters thick and 0.8 millimeters wide of interlayer materials as illustrated in FIG. 1a. The spacing between the printed lines was about 0.4 millimeters. This allowed less lines to be printed and thus printing was faster than if the entire surface was printed. A second glass substrate was placed on the printed interlayer pattern. The assembly was placed in the vacuum chamber of a vacuum platen laminator. The bottom platen was at about 100 C. After the chamber was evacuated to less than 1 torr the top platen was brought into contact with contact with the top glass substrate and pressure was applied via a pneumatic cylinder. The top platen was also at 100 C. After 10 minutes the interlayer was partially pressed out and the chamber was brought back to atmospheric pressure and the top platen was raised. The prelaminate was completely tacked especially around the perimeter and a good vacuum was retained within the voids within the interlayer. On heating at 110 C in an oven at atmospheric pressure the interlayer flowed into the voids and the lines coalesced at the boundary where the material from each line met. This allowed the interlayer that was only printed over part of the area of the substrate to form a completely uniform light red transparent layer once the interfaces between the individual lines joined together. The overall thickness of laminate decreased in the process and a full impact resistant laminate was formed.

Example 8. A continuous border was printed on a 3 millimeter thick clear glass substrate that was about 15 centimeters by about 15 centimeters with a Creality Ender3 printer using the precision gauge, red-dyed PVB filament described in Example 7. The nozzle width was about 0.8 millimeters. The nozzle offset from the glass substrate was about 0.8 millimeters. There were two passes to form a double layer printed border each with a thickness of about 0.8 mm. A 10 by 12 array of dots was uniformly printed within the printed perimeter similar to that illustrated in FIG. 2a. Each dot was about 2 millimeter thick and had and area of about 0.710 square centimeters. These dots covered only about 45% of the area of the substrate within the perimeter printed lines. A second glass substrate was placed on the printed interlayer pattern. The assembly was placed in the vacuum chamber of a vacuum platen laminator. The bottom platen was at about 100 C. After the chamber was evacuated to less than 1 torr the top platen was brought into contact with contact with the top glass substrate and pressure was applied via a pneumatic cylinder. The top platen was also at 100 C. After 10 minutes the interlayer was partially pressed out and the chamber was brought back to atmospheric pressure and the top platen was raised. The prelaminate was completely tacked especially around the perimeter and a good vacuum was retained within the voids within the interlayer. On heating at 110 C in an oven at atmospheric pressure the interlayer flowed into the voids and the dots coalesced at the boundary where the material from each line met. This allowed the interlayer that was only printed over part of the area of the substrate to form a completely uniform light red transparent layer once the interfaces between the individual lines joined together. The overall thickness of laminate decreased to about 0.76 millimeters in the process and a full impact resistant laminate was formed.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

What is claimed is:

1. A method of forming a laminate comprising:
providing a first substrate having an inner surface and an outer surface;
providing a second substrate having an inner surface and an outer surface;
printing at least one interlayer over at least a portion of the inner surface of at least one of the first substrate and second substrate;
positioning the first substrate over the second substrate so that the inner surface of the first substrate faces the inner surface of the second surface so as to sandwich the at least one interlayer therebetween;
pressing the first and second substrates together to join the first and second substrates through the at least one interlayer.

2. The method of claim 1 wherein the at least one interlayer comprises a plurality of interlayers that are printed on at least one of the first substrate, the second substrate and another interlayer.

3. The method of claim 1 wherein:
the step of printing further comprises the step of:
printing a first interlayer defining a first outer boundary on at least a portion of the inner surface of at least one of the first substrate and second substrate;
printing a second interlayer defining a second boundary on at least a portion of the inner surface of the at least one of the first substrate and second substrate,
wherein the first outer boundary and the second outer boundary are spaced apart from each other;
the step of pressing the first and second substrates together further comprises the step of:
pressing the first and second substrates so that at least a portion of the first boundary layer contacts the second boundary layer which were spaced apart from each other prior to pressing.

4. The method of claim 3 wherein the first outer boundary and the second outer boundary are completely free from contact prior to the step of pressing.

5. The method of claim 3 wherein the step of pressing further includes the step of maintaining a portion of the first outer boundary and the second outer boundary spaced apart from each other upon conclusion of the pressing step.

6. The method of claim 1 further comprising the step of applying heat to at least one of the first substrate, the second substrate and the at least one interlayer during the step of pressing.

7. The method of claim 1 wherein the step of pressing comprises the step of directing the first and second substrates between nip rollers.

8. The method of claim 1 wherein the step of printing further comprises the step of printing at least one first interlayer to the inner surface of the first substrate and printing at least one second interlayer to the inner surface of the second substrate.

9. The method of claim 8 wherein the step of pressing further comprises the step of pressing the at least one first interlayer into the at least one second interlayer.

10. The method of claim 1 wherein the step of printing further comprises the step of printing at least one interlayer in a pattern such that a portion of the inner surface of each of the first and second substrates remains unprinted; and
wherein the step of pressing further results in the formation of at least one void between the first substrate and second substrate in the step of pressing, wherein the at least one void is surrounded by a portion of the at least one interlayer.

11. The method of claim 10 further comprising the step of inserting a component between the inner surface and outer surface which remains unprinted so as to embed a component therein.

12. The method of claim 1 wherein at least one of the interlayers comprises at least one of a separator layer and an acoustic layer.

13. The method of claim 1 wherein the at least one interlayer comprises at least two interlayers, wherein the first interlayer is different than the second interlayer in at least one property.

14. The method of claim 13 wherein the inner layer of at least one of the first and second substrates comprises a non-uniform surface, and wherein the step of printing further comprises the step of print a substantially uniform layer on the non-uniform surface.

15. The method of claim 1 wherein the at least one interlayer comprises a thermochromic interlayer.

16. The method of claim 1 wherein the step of printing comprises one of the steps of printing using a plurality of pellets and using a filament.

17. The method of claim 1 wherein the at least one interlayer comprises an oriented material, comprising at least one of a liquid crystal, UV, visible and NIR reflective flakes.

18. The method of claim 1 wherein the step of printing comprises the step of printing a non-uniform thickness interlayer.

19. The method of claim 1 wherein the step of pressing further includes the step of applying a vacuum and pressure to the first substrate, second substrate and the at least one interlayer.

20. A laminate formed utilizing the process of claim 1.

21. A laminate comprising:
a first substrate having an outer layer and an inner layer;
a second substrate having an outer layer and an inner layer;
at least one interlayer, printed on the inner surface of one of the first substrate and second substrate and pressingly joined to the other of the first substrate and second substrate.

22. A method of forming a laminate comprising:
providing a first substrate having an inner surface and an outer surface;
providing a second substrate having an inner surface and an outer surface;
printing a first interlayer defining a first outer boundary on at least a portion of the inner surface of at least one of the first substrate and second substrate;
printing a second interlayer defining a second boundary on at least a portion of the inner surface of the at least one of the first substrate and second substrate,
wherein the first outer boundary and the second outer boundary are spaced apart from each other;
positioning the first substrate over the second substrate so that the inner surface of the first substrate faces the inner surface of the second surface so as to sandwich the at least one interlayer therebetween;
pressing the first and second substrates so that at least a portion of the first boundary layer contacts the second boundary layer which were spaced apart from each other prior to pressing.
